(19) United States
(12) Patent Application Publication
(10) Pub. No.: US 2009/0216676 A1
(43) Pub. Date: Aug. 27, 2009

(54) INTEGRATED MOBILE TRANSACTION SYSTEM AND METHODS THEREOF

(76) Inventors: Anup Kumar Mathur, Sunnyvale, CA (US); Sanjay Rohatgi, Saratoga, CA (US)

Correspondence Address: Michael Toback, 1027 S. De Anza Blvd #A107, Ste 329, San Jose, CA, 95129, US

(21) Appl. No.: 12/099,713

(22) Filed: Apr. 8, 2008

Related U.S. Application Data
(60) Provisional application No. 61/030,540, filed on Feb. 21, 2008.

(51) Int. Cl. G06Q 20/00

(52) U.S. Cl. 705/44; 705/35

(57) ABSTRACT

An architectural transaction arrangement for facilitating transactions is provided. The arrangement includes a set of transaction-enabled devices and an integrated mobile transaction system. The integrated mobile transaction system is configured to include at least a set of interfaces, which is configured for managing interaction between the set of transaction-enabled devices and the integrated mobile transaction system. The integrated mobile transaction system is also configured to include a format converter, which is configured to convert data packets into a format readable by at least one of the set of transaction-enabled devices and the integrated mobile transaction system. The integrated mobile transaction system is further configured to include a transaction module, which is configured to process the transactions (e.g., financial transactions, non-financial transactions, etc.) and a set of databases, which is configured for at least storing data about a set of in-system users of the integrated mobile transaction system.

### PRIORITY CLAIM

This application is related to and claims priority under 35 U.S.C. §119(e) to a commonly assigned provisional patent application entitled “Integrated Mobile Transaction System and Methods Thereof,” by Mathur et al., Attorney Docket Number MOBI-P0001P1, Application Ser. No. 61/030,540 filed on Feb. 21, 2008, all of which are incorporated herein by reference.

### BACKGROUND OF THE INVENTION

Millions of transactions may occur on a daily basis. In the current transaction system, a person may perform a variety of transactions in a typical day. Each of these transactions is usually performed in order to provide and/or acquire services and/or goods.

The different types of transactions that a person may perform may be categorized as either a financial transaction or a non-financial transaction. For a non-financial transaction, the person may have to provide some form of identification in order to verify that the person is permitted to perform the transaction. Examples of identification may include, but are not limited to driver license, health insurance card, library card, a local grocery store membership card, bank card, merchant-issued credit card, club-membership card, car insurance card, and the like. With a financial transaction, the person may not only have to provide identification but may also have to provide and/or receive some form of payment, either in the form of cash or credit, to perform the financial transaction. Examples of form of payment may include, but are not limited to cash, credit card, insurance card, debit card, check, and the like.

In an example, Robert may purchase groceries at his local merchant. To pay for the groceries, Robert may pay in cash or credit. Robert may then proceed to his doctor's office in order to get an annual checkup. If Robert is insured, Robert may have to provide the doctor's staff with his insurance card. Alternatively or additionally, Robert may pay using cash or credit. After his doctor appointment, Robert may then proceed to the library to check out a book for his child's research project. In order to check out the library book, Robert may have to provide the librarian with his library card.

Each transaction is usually enabled by having one of the parties, such as Robert, for example, reaches into his wallet, for example, to retrieve an identification card and/or a payment-enabled card, hereinafter either type of cards is referred to as a transaction-enabled card. Since a person may perform a variety of transaction daily and the type of transactions that may be performed may vary, the person may have to carry a variety of transaction-enabled cards. In an example, a typical person's wallet may include cash and a plethora of cards, such as a driver license, one or more credit cards, one or more insurance cards, one or more library cards, a set of local grocery store membership cards, a set of debit cards, a set of gift cards, and the like. Each of the transaction-enabled cards usually provides the individual with a unique form of identification. Without these items, the person may have a hard time functioning within the current transaction system.

A common problem with the current transaction system is that if a person fails to have the necessary transaction-enabled card, the person may be unable to perform the transaction. In an example, a person may want to purchase a television from a local electronic store; however, the person has forgotten to bring his credit card. Unless the person has another form of payment, such as cash or check, the person may be unable to perform the transaction. In other words, the failure to produce the required transaction-enabled card has created an inconvenience that the person has to address before the transaction may be completed. In another example, the person may be a new patient at a doctor's office; however, before the person is able to keep his doctor appointment, the person may have to provide the doctor's office with his insurance card. If the person inadvertently forgets to bring his insurance card, the person may be forced to reschedule. The inconvenience of not having proper identification and/or payment form available to perform a transaction may not only frustrate the parties involved but may also result in a loss of opportunity to the person and/or the service provider (e.g., merchant).

Another problem with the current transaction system is that trust is required in order to enable the current transaction system to function properly. The trust factor is not limited to one or a select few but may be extended to include any person and/or entity that a person may interact with. In other words, the various transactions that a person may perform daily may require the person to share his personal and/or financial data with strangers. In an example, in order to pay a restaurant bill, Robert may have to hand his credit card to a waiter. In many circumstances, the waiter is usually a person that Robert is unfamiliar with, even if Robert has eaten at the same restaurant before. In order to facilitate the transaction, Robert has to trust that the waiter does not take advantage of the situation and make an illegal copy of his credit card. In another example, Robert may have to provide a copy of his insurance card to a staff member of the doctor's office. The staff member may make a copy of Robert's insurance card to be filed away with Robert's file. By copying the person's insurance card, the data is readily available to anyone who may access the person's file. However, by allowing a copy of his insurance card to be copied, Robert has to trust that his confidential data is being protected by the doctor's office.

However, this level of trust may be violated when the transaction system is compromised. In an example, the waiter in the aforementioned example may illegally make a copy of a person credit card in order to utilize the credit card at a later time period to make fraudulent purchases. In another example, a person's wallet may be stolen resulting in all items being stored in the wallet to be lost and/or compromised. In some circumstances, the person may not immediately realize his transaction-enabled cards, for example, has been stolen. Accordingly, once the victim has realized that he has been violated, the process of minimizing the damages may be a tedious and frustrating process. In an example, the person may have to spend a significant amount of time trying to limit the damage that may arise due to the loss. In an example, the user may have to remember the items that may be stored within his stolen wallet, for example, in order to identify the different parties that may have to be notified of the stolen items. However, by the time the victim has realized his transaction-enabled cards have been compromised, his identity may already have been illegally and/or fraudulently employed. In an example, the victim's stolen Social Security card may be employed by another person to illegally obtain a driver license, credit cards, and the like. In yet another example, a person's credit card may be employed to fraudulently purchase goods. In many cases, the backlash to the victim may continue for months or even years after the person has experienced the loss.

Due to the vulnerability of the current transaction system, some people are unwilling to be a participant of the current transaction system. In an example, some people are unwilling to share personal data for fear that identity theft may occur resulting in undesirable consequences. However, the current transaction system is not especially friendly toward those who are unwilling and/or unable to actively participate. In some circumstances, the lack of participation may result in a domino effect. In an example, some people do not trust the banking system and thereby may not open a bank account. In another example, some people in undeveloped countries, for example, may be unable to establish a bank account since a financial institution may not be readily accessible. Due to a lack of a bank account, these same people may be unable to establish a credit history. Accordingly, these same people may be unable to purchase a car on credit, qualify for a mortgage loan, qualify for a credit card, purchase goods online, and the like. Accordingly, the current transaction system is not a comprehensive system since the transaction system may be unable to support the needs of different people.

### BRIEF SUMMARY OF THE INVENTION

The invention relates, in an embodiment, to an architectural transaction arrangement for facilitating transactions. The arrangement includes a set of transaction-enabled devices and an integrated mobile transaction system. The integrated mobile transaction system is configured to include at least a set of interfaces, which is configured for managing interaction between the set of transaction-enabled devices and the integrated mobile transaction system. The integrated mobile transaction system is also configured to include a format converter, which is configured to convert data packets into a format readable by at least one of the set of transaction-enabled devices and the integrated mobile transaction system. The integrated mobile transaction system is further configured to include a transaction module, which is configured to process the transactions (e.g., financial transactions, non-financial transactions, etc.) and a set of databases, which is configured for at least storing data about a set of in-system users of the integrated mobile transaction system.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 shows, in an embodiment of the invention, an overall diagram of a transaction environment with an integrated mobile transaction system.

FIG. 2 shows, in an embodiment of the invention, a simple block diagram of an integrated mobile transaction system, which may be configured to manage transaction requests.

FIG. 3A shows an example of a plurality of databases stored within integrated mobile transaction system.

FIG. 3B shows, in an embodiment of the invention, a simple example of a data type database.

FIG. 4 shows, in an embodiment of the invention, a simple diagram of a transaction module.

FIG. 5 shows, in an embodiment of the invention, a simple flow chart illustrating an example of an implementation of an integrated mobile transaction system.

FIG. 6, which shows, in an embodiment of the invention, a simple diagram of an implementation of an integrated mobile transaction system.

FIG. 7 shows, in an embodiment of the invention, a simple flowchart illustrating a process for performing authentication.

FIG. 8 shows, in an embodiment, a flow chart for implementing a multiple pin system.

FIGS. 9A, 9B, and 9C show, in an embodiment of the invention, simple flow charts illustrating examples of how the integrated mobile transaction system may be employed to handle either type of transactions.

FIG. 10 shows, in an embodiment of the invention, a simple flow chart illustrating a transaction that requires the service of a financial institution.

FIG. 11 shows, in an embodiment, a method for employing an integrated mobile transaction system to market a merchant and/or a product to the end-user.

FIG. 12 shows, in an embodiment, a flow chart illustrating how an integrated mobile transaction system may be employed to facilitate a chain relationship.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer, and/or a dedicated computing device when appropriately programmed and may include a combination of a computer/computing device and dedicated/programmable circuits adapted for the various tasks pertaining to embodiments of the invention.

As aforementioned, the prior art transaction system is a disconnected system in which the participants are responsible for keeping track of the various different transaction-enabled cards that may be assigned to them. For example, a person may be assigned a driver license, one or more credit card numbers, student identification number, insurance card, and the like. The number of different transaction-enabled cards that a person may be associated with or may have previously been associated with may overwhelm the person if the person has to account for all the transaction-enabled cards. Given that many of the transaction-enabled cards may be associated with unique identification number that is difficult to remember, a person's ability to remember one unique identification number associated with a transaction-enabled card may be a feat that many may never be able to accomplish. As a result, many people carry the transaction-enabled cards with them in order to facilitate transactions.

In one aspect of the invention, the inventors herein realized that the transaction-enabled cards may be stored and accessed electronically via a fairly common telecommunication device, such as a mobile device. In recent years, mobile devices (e.g., cellular telephone, smart devices, and the like) have proliferated and have become an essential tool throughout the world. In many different parts of the world, it is not uncommon for a person, despite his economic status, to own a mobile device. In an example, a person may not be able to afford a computer system but may own a mobile device. In another example, people may not have a bank account or even a credit card, but may possess a mobile device. The mobile device market has grown since the mobile device has become an essential tool in developing, establishing, and maintaining relationships. In one aspect of the invention, the inventors herein realized that by employing a mobile device the prior art transaction system may be revolutionized into an integrated transaction system that enables electronic transactions to occur.

In accordance with embodiments of the invention, an integrated mobile transaction system is provided as a ubiquitous platform for enabling transactions within a single comprehensive mobile architecture. In other words, everyday transactions, both financial and non-financial transactions, may occur without the various participants (e.g., consumers, merchants, financial institutions, carriers, etc.) ever having to physically share personal and/or confidential data. Although some solutions of the prior art may allow a user to perform electronic transactions, the type of transactions that may be performed are usually associated with financial transactions. In an example, a person may purchase products via the internet using his credit card. In many cases, the user is only able to perform electronic transaction with an “online presence”. In other words, the user is usually unable to go to a local grocery store and perform a transaction without providing a physical version of the transaction-enabled cards, with the exception of cash.

In this document, various implementations may be discussed using mobile telephone as an example. This invention, however, is not limited to mobile telephone and may include any mobile device, mobile computing device, wireless device, and/or connected (e.g., network, wireless network, etc.) computing device. Instead, the discussions are meant as examples and the invention is not limited by the examples presented.

In an embodiment of the invention, an integrated mobile transaction system is configured for organizing the different transaction-enable cards that a person may possess. In an embodiment, the integrated mobile transaction system may include a set of databases, which may be employed to store data about the transaction-enabled cards. Consider the situation wherein, for example, John Smith has a plethora of transaction-enabled cards, such as a driver license, three different credit cards, a variety of different insurance cards, various membership cards, and four gift cards. The data related to each of the transaction-enabled cards may be added to the set of databases. In an example, the set of databases may include the member name (e.g., John Smith), the transaction-enabled card unique identification number, expiration date (if any), the vendor, credit limit (if any), the password associated with the transaction-enabled card, an image of the transaction-enabled card, an image of the user, an image unique to the user (e.g., thumbprint), and the like. With the integrated mobile transaction system, the different transaction-enabled cards may be organized in a central location enabling John to access the data at his convenience.

In an embodiment, the set of databases are secured and/or encrypted, thereby preventing unauthorized users from illegally accessing the data. In an example, the user wants to change the password associated with one of his credit card. In order for the user to view and/or access any of the confidential data (e.g., credit card number, password, etc.) related to the credit card, the user may be required to first provide the password, for example. This security may be provided to prevent an unauthorized user from stealing the data even if the unauthorized user is able to access the user's account. The type of security measures and/or encryption methods that may be employed may be any of the different types of security and/or encryption methods that may be available.

In an embodiment, the integrated mobile transaction system is a multiple-pins arrangement. In an example, to access a user's account, a user ID and a set of passwords (e.g., pins) may have to be provided. If the user is submitting the transaction request from his personal transaction-enabled device that has been registered with the integrated mobile transaction system, the user may be able to access his account by simply providing his password, in an embodiment. The unique identification number associated with the transaction-enabled device, in one embodiment, may automatically be included in the transaction request. In an example, when a person makes a telephone call, the telephone number (e.g., unique identification number) associated with the mobile telephone is usually included in the telecommunication session request.

In an embodiment, the level of security that may be applied to a transaction-enabled card may be defined by the user. In an example, John may determine that his membership cards to local grocery stores may be of minor importance; thereby, he may associate these membership cards with a primary pin. In another example, John may have a credit card with a credit limit of $3000. To minimize his loss without placing undue restriction on his everyday transactions, John may associate the primary pin with a first monetary limit of $200. In other words, the maximum amount that may be spent from the specific credit card may be $200. If John wants to utilize the credit card for a larger purchase, for example, John may have to provide a secondary pin.

Additionally or alternatively, the user may define security access at the account level. In an example, John may set a monetary limit of $500 for a transaction. In other words, the integrated mobile transaction system is unable to process a transaction above the preset limit without John providing a secondary pin. In another example, John may set a monetary limit of $1000 per day. In other words, the total dollar amount John can spend at the primary pin level is $1000.

As can be appreciated from the foregoing, the various different instances provided are simple examples of the different implementations that may occur. Other combinations and/or more complex instances may be implemented. With a multiple-pins arrangement, the user is provided a tool for minimizing his loss in case the user's authentication data is compromised.

In an embodiment of the invention, the integrated mobile transaction system may be configured to manage the relationships between a user and the plurality of transaction-enabled card issuers. With the data organized in a centralized location that is accessible electronically, a user no longer has the burden of physically carrying the plethora of transaction-enabled cards that the user may possess. Instead, the user may send a transaction request to the integrated mobile transaction system from his transaction-enabled device, such as a mobile device, and the integrated mobile transaction system may process the transaction accordingly.

In the prior art, many of the transactions that are performed daily may require the sharing of personal data. In addition, most of these transactions normally require the user to physically handover a document, such as an identification card, and/or a credit card or cash in order for the user to complete the transaction. In an example, a college student may have to give his student identification card to a librarian or librarian assistant before he may check out library books. In another example, a student with a pre-paid meal plan may have to hand his student identification card over to a clerk before the student may access the cafeteria. Hence, forgetting to carry the card may prevent the student to perform many of his everyday activities. Also, losing the student identification card may not only cause headaches for the student but may also be financially damaging to the student.

Unlike the prior art, no physical exchange actually occurs between the parties involved. With the integrated mobile transaction system, the student may perform the same transactions without having to carry the student identification card with him. Instead, the student may send a transaction request (e.g., request to check out a book) to the integrated mobile transaction system. The integrated mobile transaction system may authenticate the student before sending the transaction request to the library. When the librarian receives the transaction request, the librarian may perform the transaction with confident since the library may be assured that the integrated mobile transaction system has already authenticated the requester.

In an embodiment of the invention, an integrated mobile transaction system is configured to handle different protocols. As can be appreciated from the foregoing, different type of transaction-enabled devices (e.g., cellular telephone, smart devices, computer systems, internet tablet, connected point-of-sales systems, point-of-entry systems, mobile telecommunication devices, smart electronic devices, etc.) may be employed to submit a transaction request. Depending upon the devices and the gateway and/or carrier that may be associated with the devices, different protocols may be employed to submit a transaction request. In an embodiment, a web converter may be provided to convert the different protocols into a web-based protocol, thereby transforming the integrated mobile transaction system into a ubiquitous platform. In other words, the integrated mobile transaction system is agnostic to the transaction-enabled device that is being employed to initiate the transaction request.

In addition, transaction requests may also vary based on the format of the transaction requests. In an example, a transaction request may be sent as a voice message, a text message, and the like. In an embodiment, a format converter may be provided for converting the plethora of transaction request into a format that may be processed. In other words, the format converter is configured to transform a transaction request into a set of standardized business process instructions, for example, that may be processed.

In an embodiment of the invention, the set of standardized business process instructions may be processed by a transaction module. In one embodiment, the transaction module is configured to perform authentication before processing the transaction request. The authentication may be performed by comparing the authentication data sent with the authentication data stored within the set of databases. Once authentication has been validated, the transaction module may process the transaction request. In an embodiment, the transaction module may send an order request to the service provider listed within the transaction request to complete the transaction request.

In an embodiment, the integrated mobile transaction system may be configured to support transaction requests from throughout the world. To facilitate the processing, the integrated mobile transaction system may be a scaleable system. In an embodiment, the transaction module may include a plurality of operation centers. In other words, as transaction requests are received, the transaction requests may be distributed to different operation centers. In one embodiment, the distribution may depend upon the current capacity of an operation center. In another embodiment, the distribution may be dependent upon the proximity of the operation center to the requester of the transaction request. As can be appreciated from the foregoing, the number of operation centers may grow as additional supports are required by the integrated mobile transaction system.

The features and advantages of the present invention may be better understood with reference to the figures and discussions that follow.

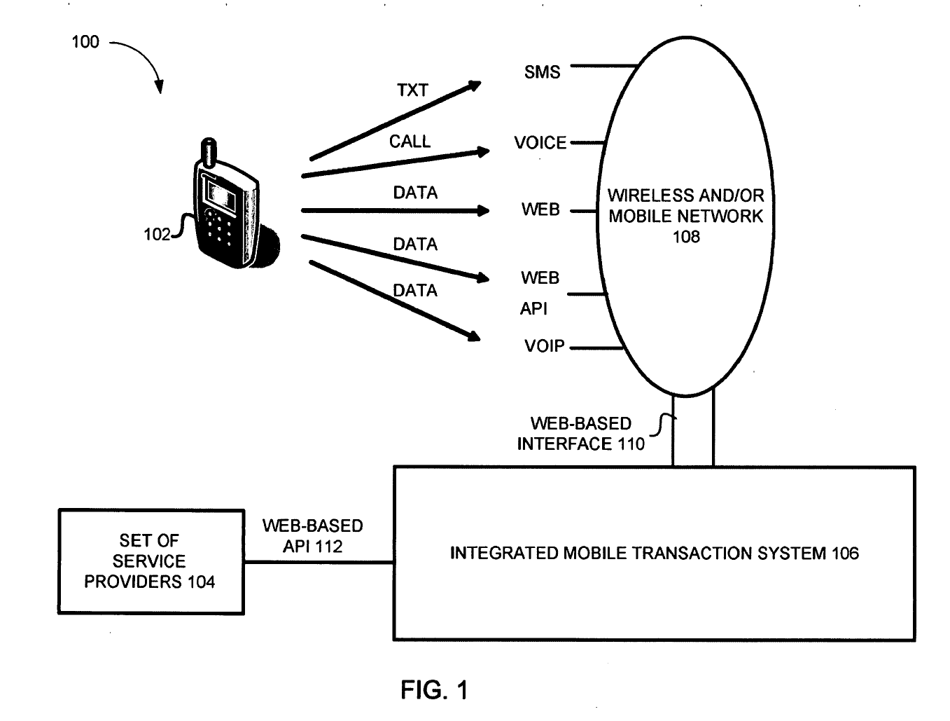

FIG. 1 shows, in an embodiment of the invention, an overall diagram of a transaction environment 100 with an integrated mobile transaction system 106. Integrated mobile transaction system 106 may be configured to manage transactions between two or more parties. The parties may include, but are not limited to, end-users (e.g., consumers) 102 and set of service providers 104 (e.g., merchants, financial institutions, etc.). In an embodiment, the transaction may be initiated by one of the party utilizing a transaction-enabled device, such as a mobile device.

Consider the situation wherein, for example, John may wants to purchase a computer system from a local electronic store. John may employ his transaction-enabled device 102 to initiate a transaction request. The transaction request may be sent in a plurality of formats, such as a text message, as a voice message, or a data message. The transaction request may be sent via a plurality of methods, such as SMS, web, voice-over-IP, voice, and the like. The transaction request may be transmitted through a wireless and/or mobile network 108, which may include one or more networks that may be capable of securing a reliable secure connection. Examples of wireless and/or mobile network 108 may include a Wi-Fi network, a cellular network, a peer-to-peer network, and the like.

The request is transferred from wireless and/or mobile network 108 to integrated mobile transaction system 106 via a web-based interface 110. Upon receiving the transaction request, integrated mobile transaction system 106 may process the request and forward the request to set of service providers 104 (e.g., local electronic store) via a web-based API 112.

As can be appreciated from FIG. 1, the transaction to purchase a computer system may be performed without the end-user (e.g., John) having to reach into his wallet to extract cash and/or a credit card. Instead, the end-user is able to make the purchase by simply sending a transaction request to integrated mobile transaction system 106 to make a payment to the merchant. Alternatively, the merchant may initiate a payment request after scanning the merchandise merchant. To complete the payment request, the end-user may have to provide his unique identifier. The transaction is completed, once the end-user has sent a confirmation. With the integrated mobile transaction system, the transaction may be securely processed without the end-user ever having to share his confidential data with a stranger (e.g., the electronic store clerk).

Accordingly, the fear of the end-user confidential data (e.g., credit card data) being stolen is minimized since the data is not shared with another party. Instead, the integrated mobile transaction system may act as a mediator between the two parties to facilitate the transaction. Additionally, concerns about transaction-enabled data being stolen may be minimized since the transaction-enabled data is stored at a remote database, in an embodiment, instead of being stored as part of a transaction-enabled card.

As can be appreciated from the foregoing, the transaction-enabled device facilitates the process by enabling the end-user to connect with the integrated mobile transaction system. In an embodiment, the transaction-enabled device does not store the transaction-enabled data. In the prior art, the loss of a wallet, for example, may have dire consequences, especially if the owner of the wallet carries many transaction-enabled cards within the wallet. However, since the transaction-enabled data is stored in a set of remote databases, the loss of the transaction-enabled device may have little or no dire consequences for the end-user. Unlike the prior art, the loss of a transaction-enabled device may not require the user to cancel all his credit cards, for example. Instead, the user may only have to purchase a new transaction-enabled device and/or cancel the service to the lost transaction-enabled device. Once the user has reestablished himself with a new transaction-enabled device, the user may be able to associate his new transaction-enabled device with his user account and disassociate his former transaction-enabled device.

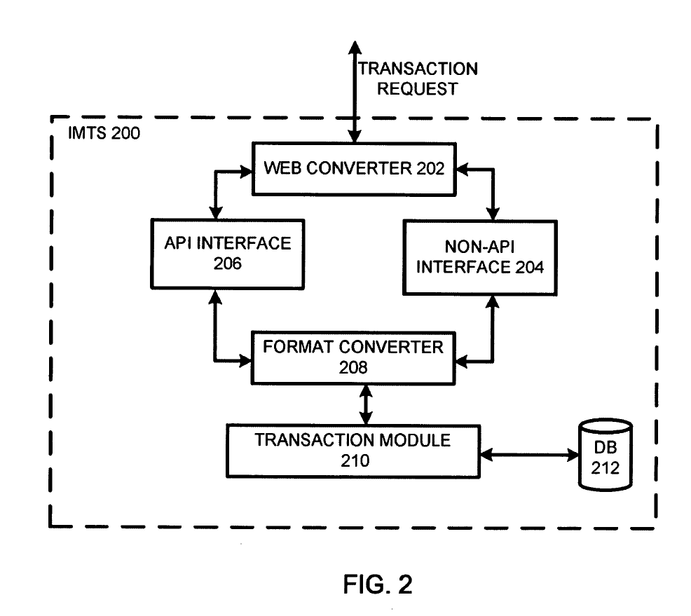

FIG. 2 shows, in an embodiment of the invention, a simple block diagram of an integrated mobile transaction system 200, which may be configured to manage transaction requests. In an embodiment, integrated mobile transaction system 200 may include a web converter 202, a set of non-application driven interfaces 204, a set of application driven interfaces 206, a format converter 208, a transaction module 210, and a set of databases 212.

In an embodiment, web converter 202 may be configured to convert data packets (e.g., transaction request, order request, confirmation, etc.) transmitted between a transaction-enabled device and integrated mobile transaction system 202 into a protocol that is transmittable through a network environment, such as the Internet. In an example, a transaction request sent via SMS may be converted by web converter 202 into an (hypertext transfer protocol) HTTP in order to enable the transaction request to be easily sent through the network environment. As can be appreciated from the foregoing, data packets may be sent via a plurality of protocols, such as SMS, MIDlet, WAP, and the like. Accordingly, the transaction-enabled device is seemingly transformed into an agnostic device since the medium by which the data packet is transmitted may be changed into a standard protocol by web converter 202 in order to enable the data packet to be sent. In other words, any type of transaction-enabled devices may be employed since web converter 202 is configured to convert the different possible protocols by which a data packet may be transmitted into a standard protocol.

In an embodiment, web converter 202 may be implemented within a gateway, such as a carrier network or an aggregator. In another embodiment, web converter 202 may be implemented outside of a gateway. In an example, web converter 202 may be implemented external to a gateway but within close proximity to the gateway. In other words, the web converter may intercept and convert the data packets before forwarding the data packets. In an example, web converter 202 may intercept a transaction request flowing from a gateway before forwarding the transaction request for processing. In another example, web converter 202 may intercept and convert a confirmation to the end-user before forwarding the confirmation to a gateway.

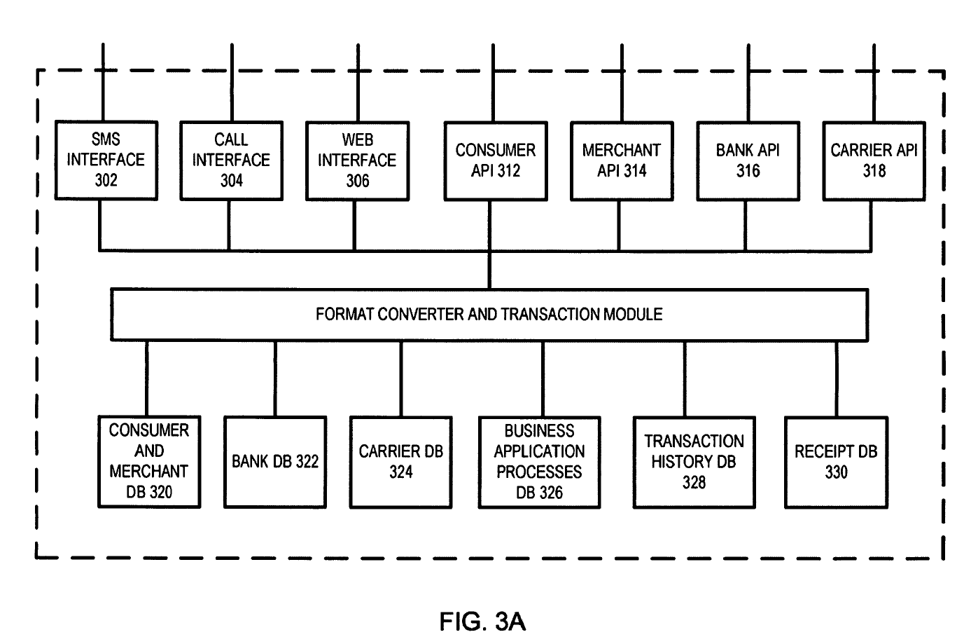

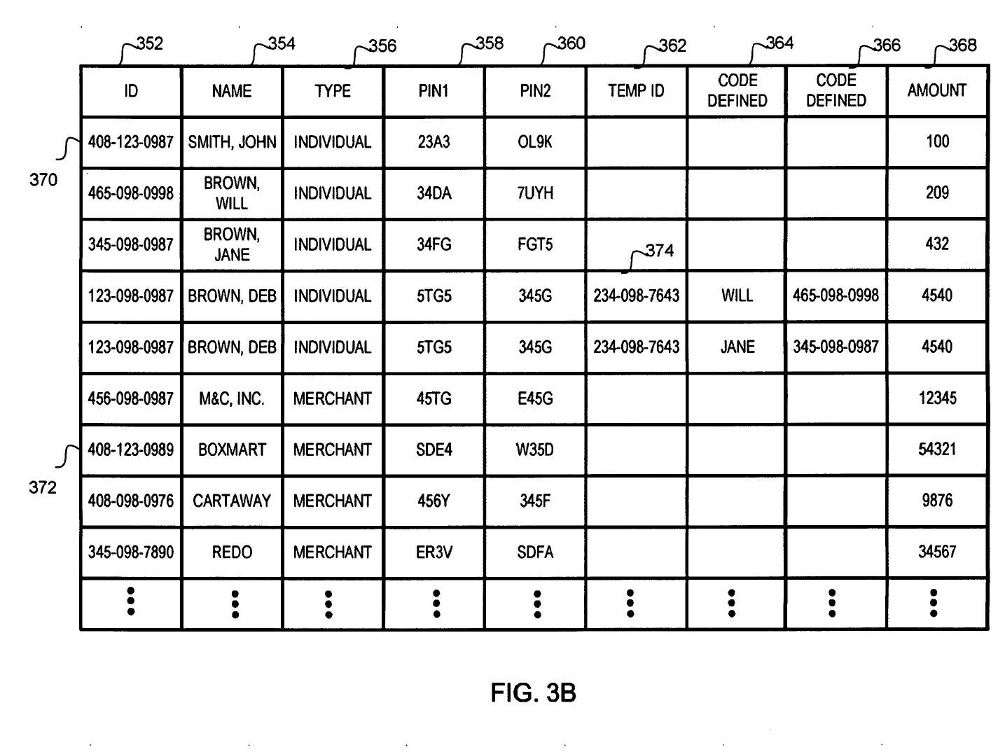

In an embodiment, integrated mobile transaction system 200 may include a set of interfaces. In an embodiment, the set of interfaces may be a non-application driven interface 204 or application-driven interface 206. As discussed herein, an application driven interface refers to an interface that may have been created by a third-party vendor to facilitate interaction between a transaction-enabled device and the integrated mobile transaction system. FIG. 3A shows, in an embodiment, examples of different interfaces that may be employed. In an example, non-application interface may include standard interfaces, such as a SMS interface 302, a call interface 304, and a web interface 306. Examples of an application interface may include third-party interfaces, such as a consumer API 312, a merchant API 314, a bank API 316, a carrier API 318, and the like. In an embodiment, the interface that may be employed may depend upon the data packet. In an example, a transaction request from an end-user sent via SMS, may be handled by SMS interface 302. In another example, an order request to a merchant may be sent via a merchant API 314.

As can be appreciated from the foregoing, a data packet may be sent in a plurality of format, such as data, voice, text, and the like. In an embodiment, format converter 208 may be configured to convert a data packet into a format that may be handled by the recipient. In an example, a transaction request has been sent as a text message. Before the transaction request may be processed, format converter 208 may be employed to convert the transaction request into a standard format. To perform the conversion, format converter 208 may include logic for analyzing the transaction request, determining the format of the transaction request, and applying a set of conversion rules to convert the transaction request into a format that may enable a transaction module 210 to process the transaction request. In another example, an order request is being sent to a service provider. Before the order request may be sent, format converter 208 may be employed to convert the order request into a format that may be handled by the specific service provider. For example, the service provider may only receive data via a web interface. Thus, the order request may be sent in a web format.

In an embodiment, integrated mobile transaction system 200 may include transaction module 210. In an embodiment transaction module 210 is configured to process transaction requests. Before processing the transaction request, transaction module 210 may validate the identification of the requester. Validation may occur by accessing set of databases 212, in an embodiment. In an example, transaction module 210 may compare the data being received from transaction request, such as the unique identifier (e.g., telephone number) of the transaction-enabled device, the gateway transmitting the transaction request, a password, and the like, against data stored within set of databases 212 to verify the identify of the requester.

Once validation has occurred, transaction module 210 may process the transaction request. In an example, the request may be a request to purchase a computer system from a local electronic store. To process the request, transaction module 210 may check set of database 212 to determine the method of payment that may be associated with the requester. For example, the requester may have defined method of payment via a credit card.

In another embodiment, transaction module 210 may be configured to perform geographic conversion based on the positioning of the requester, such as the transaction-enabled device. In an example, if the requester, who is a resident of the United States, is traveling in England, the transaction request may be handled by a carrier that is different than one that is associated with the user. In an example, an England-based carrier may perform the connection for the transaction request. Since transaction module 210 may be able to identify the geographic displacement of the user, transaction module 210 may activate other modules that may be required to complete the transaction request. In an example, a currency converter module may be activated to perform the currency exchange, thereby enabling the requester to make a purchase or payment, for example, with a real-time (or almost real-time) conversion rate.

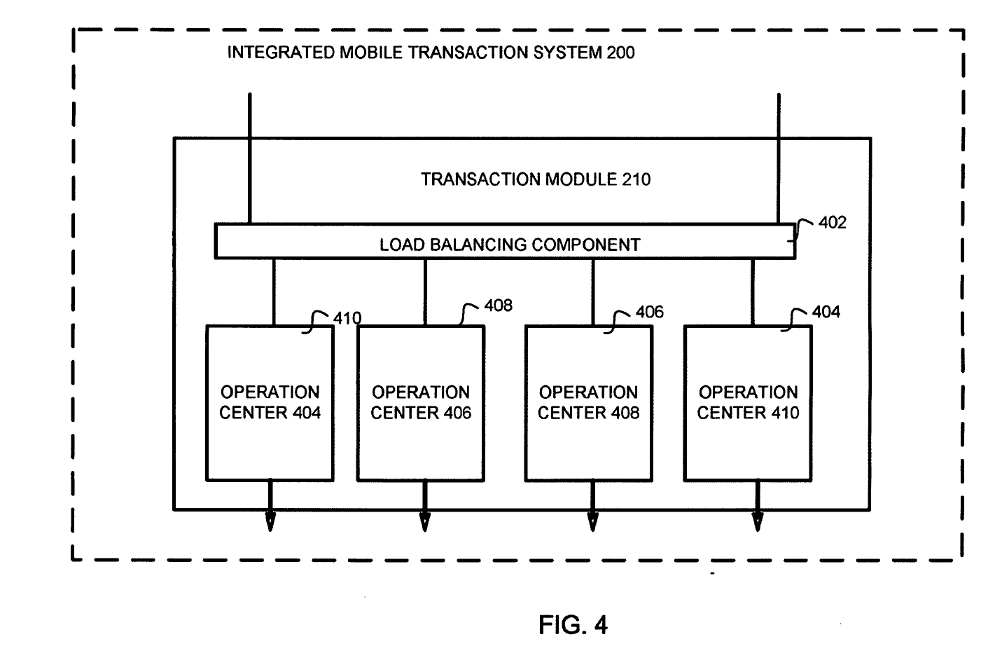

As can be appreciated from the foregoing, transaction module 210 may be handling data packets from throughout the world. To facilitate processing, transaction module 210 may include a plurality of operation centers (404, 406, 408, and 410), as shown in FIG. 4. With a plurality of operation centers, transaction module 210 becomes a scalable modular module, thereby enabling a global transaction environment. In an embodiment, transaction module 210 may include a load balancing component 402, which may be configured to direct the data packets to one of the operation centers for processing. In an example, data packets coming from an England-based carrier may be handled by an operation center in France instead of an operation center in China. Additionally or alternatively, load balancing component 402 may direct the data packet to a less-utilized operation center, even if the operation center may be located physically farther. Accordingly, a scalable transaction module enables the integrated mobile transaction system to adapt as membership changes.

Once transaction module 210 has processed the transaction request, transaction module 210 may send an order request to a service provider, such as a local electronic store. Upon receiving the order request, the service provider may perform the request and send back to transaction module 201 an order confirmation. For example, if the person is buying a computer system, then the merchant may accept the payment and send back an order confirmation indicating that the transaction has been performed. In another example, if the service provider is a library, an order confirmation may be sent back to transaction module 210 indicating that the transaction has been completed. In yet another example, if the transaction request requires the assistance of a financial institution, such as the user wants to transfer money from his account into another user account, then transaction module 210 may be configured to send an order request to a financial institution in order to have the transaction performed.

Once the order request has been completed by the intended recipient, transaction module 210 may then provide a transaction confirmation to the requester. In an embodiment, if a receipt is required, transaction module 210 may send an electronic version of a receipt to the requester's transaction-enabled device.

In an embodiment, integrated mobile transaction system 200 may include set of databases 212. Accordingly, set of databases 212 may be a single large database or a plurality of databases. The set of databases 212 may be relational and may interact with one another.

As can be appreciated from the foregoing, set of databases 212 may be configured to store data FIG. 3A shows an example of a plurality of databases stored within integrated mobile transaction system 200. Examples of databases may include, but are not limited to a consumer and merchant database 320, a bank database 322, a carrier database 324, a business application processes database 326, a transaction history database 328, and a receipt database 330.

In an example, a data type database (e.g., consumer and merchant database 320, bank database 322, carrier database 324, etc.) may be configured to store data about subscriber to the integrated mobile transaction system FIG. 3B shows, in an embodiment of the invention, a simple example of a data type database. A data type database may include a unique identification number (352), a member name (354), a user type (356), a set of pins (358 and 360), a temporary ID (362), a set of short codes (364 and 366), a monetary limit (368), and the like. In an example, at a row 370, an individual John Smith may be associated with a unique ID of 408-123-0987. He has set up two pins and has defined his monetary limit at $100. In another example, at a row 372, similar data for a merchant has been established.

In yet another example, Deb Brown may have entered similar type of data as John Smith. However, she has also established a temporary ID 374. With a temporary ID, transaction request may also be received from the transaction-enabled device associated with the temporary ID. For example, while Deb Brown is working overseas for three month she may be utilizing a temporary mobile telephone. Instead of having to enter her user ID each time she wants to make a transaction request, she can associate the telephone number associated with her mobile telephone with her user's account; thereby enabling her to bypass the requirement to enter her user ID each time she wants to initiate a transaction request.

In another example, a transaction type database (e.g., transaction history database 328, receipt database 330) may be configured to keep a history of transactions performed by integrated mobile transaction system 200. Examples of data may include a record of the transaction request received, the order request sent, the confirmation sent, the receipt sent, and the like.

In yet another example, a process type database (e.g., business application process database 326) may be configured to store process rules. In other words, a process type database may be employed to allow subscribers to define rules that may be applied to each subscriber. For example, a consumer may define rules specifically on how certain transaction request may be handled. In another example, a merchant may define rules on how an order request may be sent. In an embodiment, process type database may also be employed by an administrator of the integrated mobile transaction system to define rules that may be applied generically to all subscribers or to a group of subscribers. In an example, a process rule may be established for changing a password. In an example, a subscriber may be forced to change his password every six months.

As can be appreciated from the foregoing, an integrated mobile transaction system simplifies a disconnected transaction system into a comprehensive transaction arrangement. With a simple transaction-enabled device, such as a mobile device, a person may become an active member of the integrated mobile transaction system. Membership may be acquired by creating an account with the integrated mobile transaction system.

In an example, a person may become a member by calling a designated number to activate membership. In another example, a person may join by creating a web account. In yet another example, a person may join by signing up with another member (e.g., such as a local merchant that is a member of the integrated mobile transaction system). For example, the in-system user may send via his transaction-enable device a set of messages to the transaction-enabled device of the out-of-system user. The set of messages may include instructions and/or application enabling the out-of-system user to join the integrated mobile transaction system. In another example, the integrated mobile transactions system may send the out-of-system user's transaction-enabled device a set of messages with instructions and/or application for enabling the out-of-system user to become an in-system user. Similarly, a service provider may become a member by any of the aforementioned methods.

With an integrated mobile transaction system, individuals and/or service providers that may have previously been “off the grid” may now share in the benefits that have previously eluded them. In an example, in many part of the developing world, cash is the medium of exchange. For many, the reason for the lack of credit usage may be partly due to the unavailability of local financial institutions. In one embodiment of the invention, the integrated mobile transaction system makes the banking system available to everyone. Traditionally, to create a bank account with a financial institution, the person may have to have physical access to the financial institution. In an example, the person may walk into a bank and open a banking account with $100. However, financial institution may not be physically available in many parts of the world, especially in small rural villages of developing or third-world countries. As a result, people who reside in areas without access to a financial institution may be unable to enjoy the service provided by the financial institution.

In recent years, internet banking has enable people who are not geographically close to a financial institution to create a banking account with the financial institution. One method for creating the new banking account may require the person to transfer money from another banking account. However, a person without a current banking account is unable to execute this method.

Another method for creating a new banking account may require the person to send the money as a certified check (e.g., money order, bank check, and the like). With this method, a person may purchase a money order, for example, at his local store and send the money order to financial institution to open a new banking account. This method has several disadvantages. One, the method requires the person to have faith that the person's hard-earned money is securely held in a remote location. For many people, being unable to readily access their money may cause mistrust. Second, the method usually requires the money to be sent in as a certified fund. In other words, the person may have to pay to convert his money over to a certified fund. Some people may be unwilling to pay the cost of sending their money to a third party that is not readily available. Third, the person may not have ready access to his money. Thus, if the person needs his money to perform a transaction, the process of retrieving the fund may require time that some people may be uncomfortable with.

In one aspect of the invention, the inventors herein realize that an integrated mobile transaction system may be transformed into a comprehensive banking system by enabling each member to act as a personal banker. In other words, with the integrated mobile transaction system, a person who does not have access to a financial institution may be able to share in the benefit of a banking structure (e.g., store his money electronically, perform electronic transactions, etc.). Consider the situation wherein, for example, a person resides in a small remote village with no access to a financial institution. By becoming a member of the integrated mobile transaction system, the person may go to a member of the integrated mobile transaction system, such an in-service merchant, to deposit his money. The user may send a transaction request to the integrated mobile transaction system to move $100, for example, from the merchant's account for example, into his account. Upon receiving the transaction request, the integrated mobile transaction system may verify the transaction with the merchant. Once the order confirmation has been received from the merchant, the integrated mobile transaction system may credit the user's account with $100 and debit the merchant's account accordingly. With the integrated mobile transaction system, members of the system are seemingly transformed into “mini-tellers” thereby enabling a banking structure to propagate throughout the world without the “brick and mortar cost”.

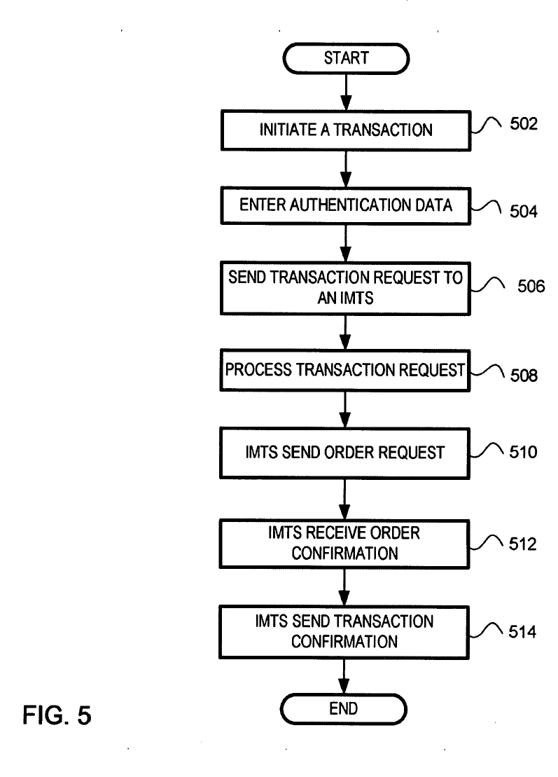

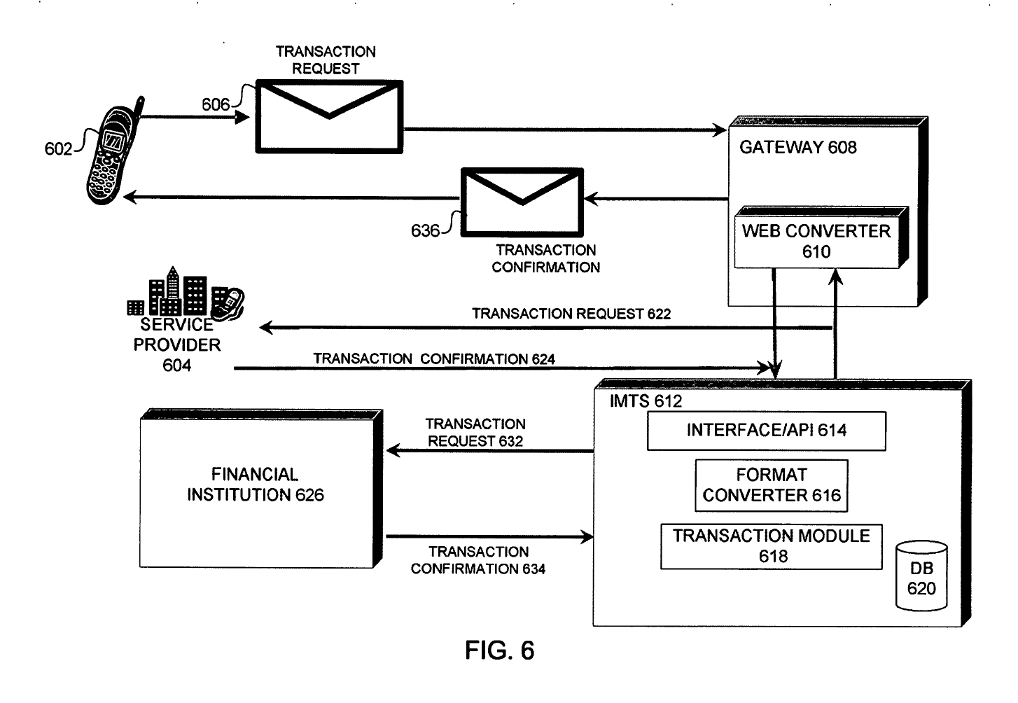

With a virtual banking system, not only is the integrated mobile transaction system able to process non-financial transactions but also financial transactions. FIG. 5 shows, in an embodiment of the invention, a simple flow chart illustrating an example of an implementation of an integrated mobile transaction system. FIG. 5 will be discussed in relation to FIG. 6, which shows, in an embodiment of the invention, a simple diagram of an implementation of an integrated mobile transaction system.

At a first step 502, a transaction is initiated. Consider the situation wherein, for example, a user with a transaction-enabled device 602 wants to perform a transaction with a service provider 604, such as, for example, a retail store, a bank, a government office, a doctor's office, an insurance agency, and the like. As discussed herein, a transaction-enabled device refers to a device with processing power and is capable of connecting with a gateway. Examples of transaction-enabled device may include, but are not limited to, a cellular phone, a smart device, an internet tablet, and the like.

At a next step 504, authentication data may be provided. In an embodiment, a username and a password is provided by the requester in transaction request 606. In an embodiment, a username is not required if the requester is utilizing his personal transaction-enabled device. The unique identifier (e.g., telephone number, MAC address, etc.) associated with transaction-enabled device 602 may be considered as the requester's username, in an embodiment. However, if the requester is employing a transaction-enabled device that is not associated with the requester, such as a friend's mobile device, for example, the username may be required to be entered in order for integrated mobile transaction system 612 to validate the requester.

At a next step 506, the transaction request is sent to the integrated mobile transaction system. In an example, once transaction request 606 has been initiated, transaction request 606 may be sent via a gateway 608. Gateway 608 may be a carrier network, for example, such as a cellular network, a TCP network, a Wi-Fi network, a peer-to-peer network, and the like. Within gateway 608 may be a web converter 610. Since a plurality of different protocols (e.g., SMS, mobile web applet (e.g., Midlet), mobile web (e.g., WAP), voice, etc.), may have been utilized to transmit transaction request 606, web converter 610 may be configured, in an embodiment, to convert transaction request 606 into a web-based protocol, thereby enabling transaction request 606 to be sent to an integrated mobile transaction system 612 for processing. As can be appreciated from the foregoing, b, employing a web converter, potential problem with sending a transaction request in a protocol that may be received by integrated mobile transaction system 612 is substantially eliminated.

In an embodiment, web converter 610 may be implemented at the gateway. In another embodiment, web converter 610 may be implemented within the integrated mobile transaction system and may be configured to first receive the transaction request in order to convert the data into a protocol that may enable the transaction request to be sent through the network. With web converter 610, a transaction-enabled device is seemingly transformed into an agnostic device since the medium by which the transaction request is sent may be transformed into a standard format by web converter 610 in order to enable transaction request 606 to be sent.

In an embodiment, the transaction request is sent to a transaction module via an interface/API. In an example, once web converter 610 has completed the conversion, transaction request 606 may be forwarded to transaction module 618 via an interface/API 614. As aforementioned, different types of interfaces/API may be employed to facilitate interaction between integrated mobile transaction system 612 and its subscribers, which may include the end-user at transaction-enabled device 602, service provider 604, financial institution 626, and the like. In an example, if the user at transaction-enabled device 602 is an end-user, such as a consumer, then transaction request 606 may be configured to be received by a consumer interface. In another example, if a transaction request includes making payment to a merchant, then an order request may be sent via a merchant interface.

As can be appreciated from the foregoing, transaction request 606 may be sent in different format, such as data, voice, text, and the like. In order to process transaction request 606, a format converter 616 may be employed to convert transaction request 606 into a format that may that may be processed. Additionally, format converter 616 may analyze transaction request 606 to identify the gateway associated with transaction-enabled device 602. The data about the gateway may be one of the data that transaction module 618 may employ to validate the authentication of the requester.

Once format converter 616 has completed the conversion task, transaction request 606 may be forwarded to a transaction module 618 of integrate mobile transaction system 612 for processing, at a next step 508.

Before processing transaction request 606, transaction module 618 may authenticate the requester. In an embodiment, authentication may occur by accessing a set of databases 620. In an embodiment, set of databases 620 may include data (e.g., member names, gateway hosting member's transaction-enabled device, password, and the like. With the data gathered from transaction request (e.g., unique identifier of transaction-enabled device 602, gateway associated with transaction-enabled device, password entered, etc.), transaction module 618 may validate the requester's identity.

If the transaction is initiated from a country different than the one associated with the subscriber in set of databases 620, for example, transaction module 618 may be configured to perform geographic conversion. In an example, if the requester, who is a resident of the United States, is visiting his relatives in China, the transaction request may be handled by a Chinese-based carrier. Since transaction module 618 may be able to identify the geographic displacement of the requester, transaction module 618 may be configured to activate other modules (e.g., currency converter) that may be needed to facilitate transaction request 606.

Once transaction module 618 has processed the transaction request, transaction module 618 may send an order request (e.g., transaction request 622 or transaction request 632) to the intended recipient of transaction request 606, such as a service provider, at next step 510. For example, if user of transaction-enabled device 606 is buying a chocolate bar, then transaction module 618 may send transaction request 622 to service provide 604 (e.g., merchant). Upon receiving the order request, the merchant (i.e., service provider 604) may process the payment. In another example, if transaction request 606 requires the assistance of a financial institution, such as the user wants to transfer money from his account into another user's account, then transaction module 618 may send transaction request 632 to financial institution 624 to perform the transaction.

Upon receiving the order request, at a next step 512, the service provider may perform the request and send back to the transaction module an order confirmation (e.g., transaction confirmation 624, transaction confirmation 634, etc.). Steps 510-512 may be repeated if the transaction module is required to interact with more than one service provider. In an example, if the user wants to withdrawal money from his bank account in order to pay for a purchase. Transaction module 618 may first have to interact with financial institution 626 to withdraw the required monetary fund and deposit the fund into the user's account of end-user 602. Then transaction module 618 may interact with service provider 604 to inform service provider 604 that sufficient fund is available to complete the transaction.

At a next step 514, the integrated mobile transaction system may send a transaction confirmation to the requester. In an example, once the order confirmation has been received, transaction module 618 may create a transaction confirmation 636 that may be sent to the requester at transaction-enabled device 606 to inform the requester that the transaction has been completed. In an embodiment, if a receipt is required, transaction confirmation 636 may include an electronic receipt or a link to an electronic receipt. In an embodiment, the receipt may be saved in set of databases 620.

As can be appreciated from FIGS. 5 and 6, the integrated mobile transaction system facilitates transaction between at least two participants. In other words, any member of the integrated mobile transaction system may become a “service provider” since each member is able to send and receive payments without requiring additional hardware. In the prior art, an individual who is not a merchant member of a credit card network, for example, may only be able to barter or accept cash for his products (e.g., homemade jams). However, with the integrated mobile transaction system, each member is seemingly transformed into a “micro merchant”. In other words, each member is capable of receiving electronic payments from other members; thereby, electronic financial transactions may be conducted by each member without requiring the member to incur the expense of setting up a merchant's presence.

With the integrated mobile transaction system, the cost associated with financial transaction may be significantly reduced. In an example, the merchant is no longer required to purchase and/or lease hardware that may enable the merchant to accept credit payment. In another example, the network cost (e.g., carrier cost, credit card fees, etc) associated with electronic payment may be substantially reduced. For example, in the prior art, a merchant may have to establish a telephone line with a landline carrier in order to process credit card payments. However with the integrated mobile transaction system, no additional telephone line may have to be established. Instead, since the member may already subscribe to a carrier network (for his mobile telephone, for example), the member may employ the same carrier network to perform the transaction.

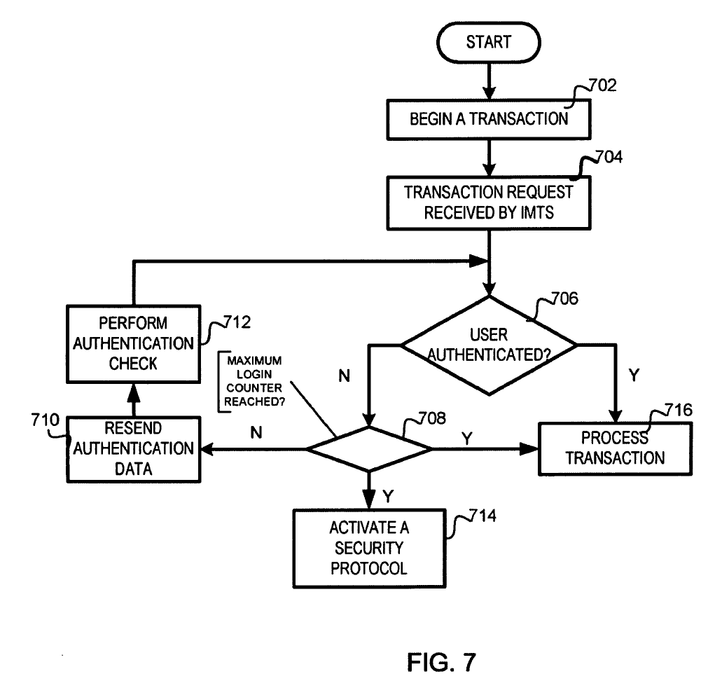

As aforementioned, before a transaction request may be processed, the requester's identify may first have to be authenticated. FIG. 7 shows, in an embodiment of the invention, a simple flowchart illustrating a process for performing authentication.

At a first step 702, a transaction is initiated.

At a next step 704, the transaction request is received by the integrated mobile transaction system. Before processing the transaction request, the integrated mobile transaction system may validate the user. In an embodiment, the transaction request may include authentication data, such as a user ID, a password, the gateway associated with the transaction-enabled device, and the like. As aforementioned, the user ID may be a unique identifier that may be associated with the transaction-enabled device. In an example, the unique identifier may be the telephone number associated with the mobile device (i.e. transaction-enabled device). In another example, the unique identifier may be a MAC address associated with a computer system (i.e., transaction-enabled device). In an embodiment, if the transaction request is initiated from a transaction-enabled device that is associated with the requester, the requester is not required to provide the user ID since the user ID may be sent automatically as part of the transaction request. However, if the requester is employing a guest transaction-enabled device, the requester may have to manually enter the user ID.

At a next step 706, the integrated mobile transaction system may validate the authentication data received. In an embodiment, a transaction module may compare the authentication data received against data about the subscriber stored within a set of databases.

If the authentication data is accurate, then at a next step 714, the transaction request is processed.

However, if one or more of the authentication data is inaccurate, then at a next step 708, the integrated mobile transaction system may check a log-on counter to determine if the maximum log-in has been reached. In an embodiment, a log-on counter may be activated when a user tries to log onto an account. In an example, when the user initiates a transaction, the log-in counter may be set to one. Each time the user is unsuccessful, the log-on counter is increased. The log-on may be reset each time the user has successfully log onto his account, in an embodiment.

If the maximum number of log-on has not occurred, then at a next step 710, a request may be sent for the authentication data to be resent. In an embodiment, the request may include an option for the user to create a new account.

At a next step 712, the integrated mobile transaction system may perform the authentication check again. Steps 706-712 may be repeated until the user has successfully log onto his account or the maximum number of log-on has been reached.

If the maximum number of log-on has been reached, then at a next step 714, the integrated mobile transaction system may activate a security protocol. In an embodiment, the security protocol may include terminating the transaction and locking the account. If the failed attempt to log onto the account is being performed from a guest transaction-enabled device, the integrated mobile transaction system may send an alert to the transaction-enabled device alerting the owner of the device of an attempt by an individual to log onto the user account, in an embodiment. If additional failed attempt continue to occur after the alert to the transaction-enabled device, an alert may be sent to the gateway associated with the transaction-enabled device alerting the gateway that the continual failed attempt to log onto the user account may be an indication of the transaction-enabled device being stolen, in an embodiment.

However, if the authentication data is valid, then at a next step 716, the transaction is processed.

In the prior art, a lost transaction-enabled card may mean that the victim may be liable for up-to the credit limit of the transaction-enabled card. The inventors herein realized that many people may have a spending pattern and may be comfortable with spending a certain dollar limit on each purchase. Usually, the dollar limit is well-below the credit limit of the transaction-enabled card. To minimize the loss that a victim may suffer, a multiple pins system may be implemented, in an embodiment. In other words, an end-user of the integrated mobile transaction system may define a set of monetary limits and associate each monetary limit with a password. In an example, an end-user may set a first monetary limit at $499. In other words, to perform financial transaction with a monetary limit beyond $499 may require a secondary pin. If by chance an end-user's account is compromised, the loss that may be experienced by the end-user may be minimized since the likelihood of both pins being compromised may be less.

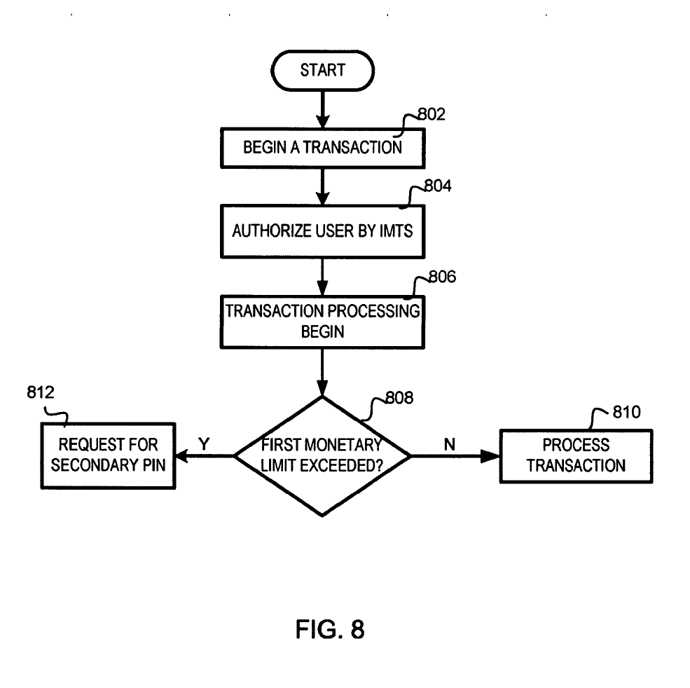

FIG. 8 shows, in an embodiment, a flow chart for implementing a multiple pin system. To facilitate discussion, the flow chart illustrates a double pins system. However, the integrated mobile transaction system is not limited to a double pins system and may be adjusted as needed.

At a first step 802, a transaction request is initiated. Consider the situation wherein, for example, a transaction request for purchasing a $600 computer system has been initiated.

At a next step 804, the integrated mobile transaction system authenticated the requester.

Once the requester has been authenticated, the integrated mobile transaction system may process the transaction request, at a next step 806.

For a financial transaction, the integrated mobile transaction system may compare the transaction amount against a first monetary limit, at a next step 808. In other words, the integrated mobile transaction is checking to determine fund availability for the user at the primary pin level. As discussed herein, fund availability may include credit available through transaction-enabled cards, prepaid account (such as deposit account with the integrated mobile transaction system), funds available through financial institutions, and the like. If the first monetary limit has not been reached, at a next step 810, the transaction request is processed.

However, if the first monetary limit has been reached, at a next step 812, the integrated mobile transaction system may request for a secondary pin. In an example, the first monetary limit is set at $499. Since the transaction request is for $600, the first monetary limit has been set and a secondary pin is required before the transaction may be processed.

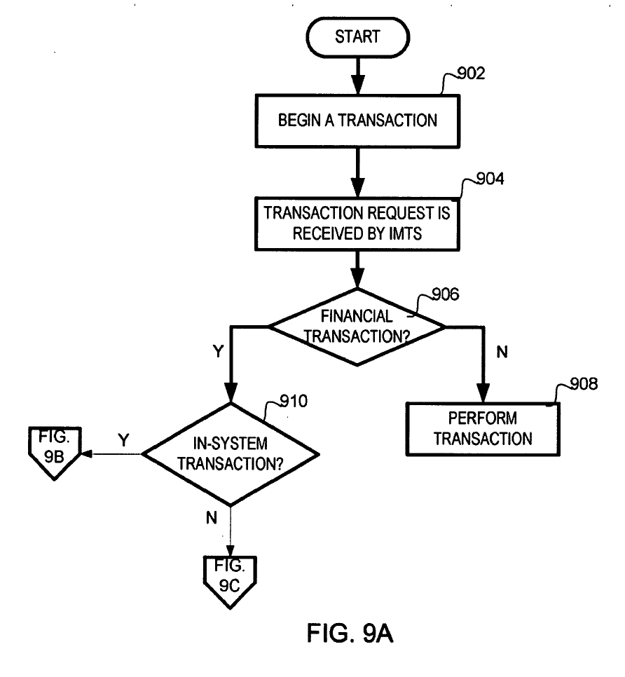

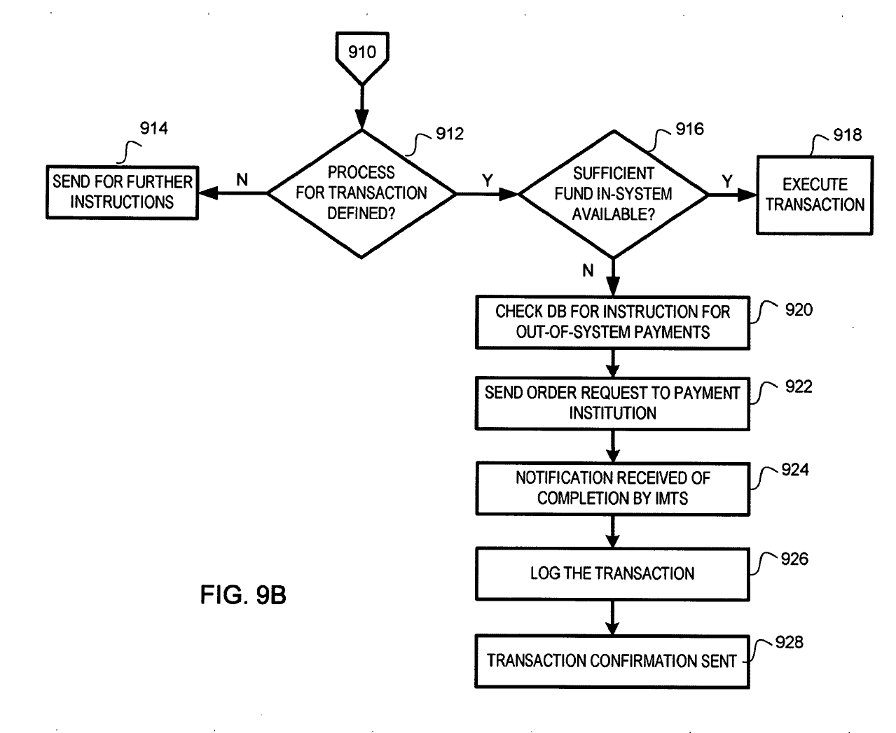

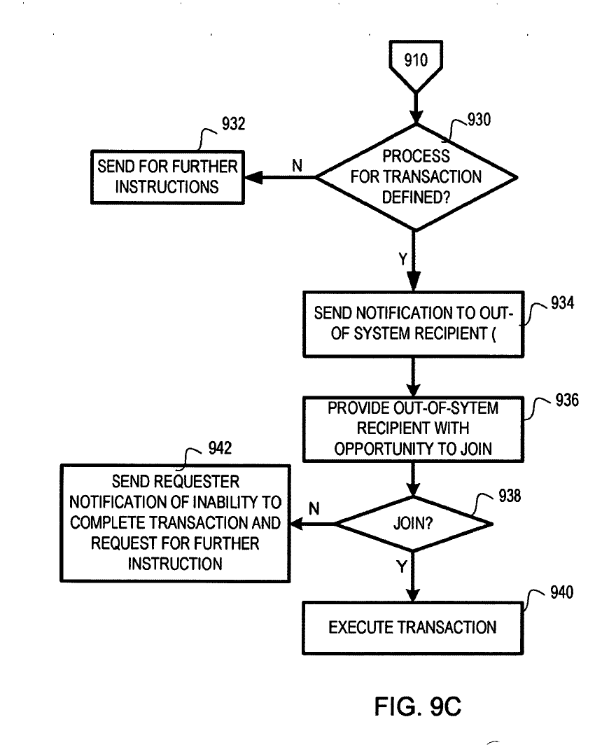

As aforementioned an integrated mobile transaction system is configured to handle both financial and non-financial transactions. FIG. 9A shows, in an embodiment of the invention, a simple flow chart illustrating an example of how the integrated mobile transaction system may be employed to handle either type of transactions.

At a first step 902, a transaction request is sent.

At a next step 904, the transaction request is received by an integrated mobile transaction system.

At a next step 906, the integrated mobile transaction system may analyze the transaction request to determine if the transaction request is a financial transaction request.

If the transaction request is not a financial transaction request, at a next step 908, the integrated mobile transaction system may perform the transaction.

However, if the transaction request is a financial transaction request, at a next step 910, the integrated mobile transaction system may analyze the transaction to determine if the transaction is an in-system transaction.

If the transaction is an in-system transaction, then at a next step 912 (of FIG. 9B), the integrated mobile transaction system may check a database to determine if the process for transaction has been defined. In an example, the requester may have defined rules for making payments.

If no payment data has been established, at a next step 914, the integrated mobile transaction system may send a message to the requester at the transaction-enabled device requesting for further instruction and/or payment data.

If method of payment has been defined, at a next step 916, the integrated mobile transaction system may check the requester's account to determine if the subscriber has sufficient in-system fund (i.e., fund in the user's member account). In an embodiment, besides handling the transactions for a user, the integrated mobile transaction system may also act as a financial institution for the user. In an example, the user may have deposited $300 with the integrated mobile transaction system, thereby enabling the user to perform financial transactions without having to access outside funds (e.g., fund from a bank, credit cards, etc). By acting as a “financial institution”, the integrated mobile transaction system is able to empower members who may not have access to a bank and/or credit card to perform financial transactions.

If sufficient fund is available, at a next step 918, the transaction is executed.

However, if the user has insufficient in-system fund, then at a next step 920, the integrated mobile transaction system may check the database to determine the method for out-of-system payments. As discussed herein, out-of-system payment may refer to payments via bank fund, credit card, debit card, and the like. In an example, the requester may have requested that all transaction requests be paid utilizing his credit card. In an embodiment, the requester may have defined a hierarchy for making payment. In other words, the requester may have configured and/or defined methods of payments based on availability of in-system funds, across various transaction-enabled cards, and available out-of-system funds. In an example, the requester may have established a payment rule such that his credit card is utilized first to make all payment before accessing his bank account. Unlike the prior art, the integrated mobile transaction system is therefore able to combine multiple available funds to facilitate a transaction request, which may otherwise have been declined in the prior art. In an embodiment, the integrated mobile transaction system may request for a secondary password if the transaction amount is above the monetary limit associated with the first password. In other words, even if the requester may have sufficient fund in his account, the integrated mobile transaction system may not be able to perform the transaction if the requester has established monetary limit.

At a next step 922, an order request may be sent to the designated payment institution. In an example, the integrated mobile transaction system may send an order request for a $200 credit card payment to be made against the user's credit card.

At a next step 924, the integrated mobile transaction system may receive notification of the execution of the order request.

At a next step 926, the integrated mobile transaction system may log the transaction into a transaction history database.

At a next step 928, a transaction confirmation may be sent to the requester.

Returning to step 910, if the transaction is not an in-system transaction, then at a next step 930 (FIG. 9C), the integrated mobile transaction system may check a database to determine if the process for transaction has been defined.

If no payment data has been established, at a next step 932, the integrated mobile transaction system may send a message to the requester at the transaction-enabled device requesting for further instruction and/or payment data.

However, if process has been defined, at a next step 934, the integrated mobile transaction system may send a notification to the out-of-system recipient informing the recipient about the pending transaction. In an embodiment, the contact information may be provided by the user, may be stored inside the user's member account, and/or the integrated mobile transaction system may employ a third-party service locator to retrieve the contact data.

At a next step 936, the integrated mobile transaction system may provide the out-of-system recipient with an opportunity to join the system.

At a next step 938, the integrated mobile transaction system may check the response from the out-of-system recipient to determine if the out-of-system recipient wants to join.

If the out-of-system recipient wants to join, then the integrated mobile transaction system will assist the out-of-system recipient with the subscription process.

Once the recipient has joined, at a next step 940, the integrated mobile transaction system is able to execute the transaction and send the requester a confirmation.

However, if the out-of-system recipient does not want to join, then at a next step 942, the integrated mobile transaction system may inform the requester about the inability to complete the transaction and ask for further instruction.

As can be appreciated from the foregoing, even if the out-of-system recipient is unwilling to accept membership, the integrated mobile transaction system may assist the requester by providing alternative solutions. Consider the situation wherein, for example, the requester wants to send $100 to his sister. If his sister is unwilling to join, the requester may still employ the integrated mobile transaction system to send the fund to his sister via an alternative method. For example, the integrated mobile transaction system may move funds (e.g., perform fund transfer) from his user's account to his sister's bank account. In another example, the integrated mobile transaction system may utilize an in-system merchant (located close to his sister) as a mini-teller, thereby enabling his sister to receive the fund by providing a confirmation number to the local merchant. In another example, his sister may be able to indicate preference of location and identify an in-system service provider (e.g., merchant, financial institution, etc.) to receive these funds by providing a confirmation number or receipt utilizing her transaction-enabled device.

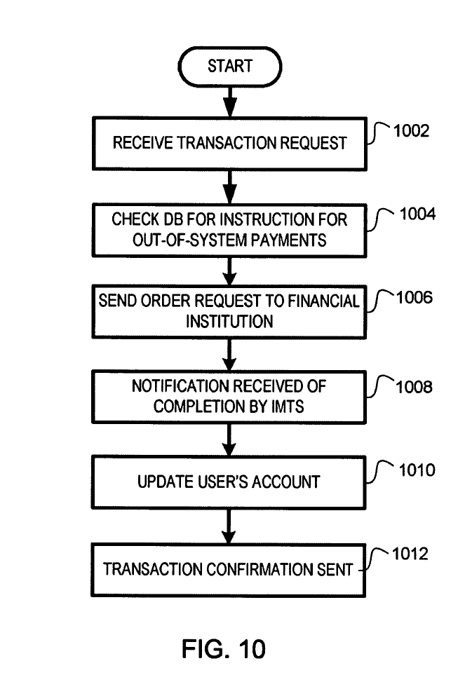

As aforementioned, some financial transactions may require the assistance of a financial institution. FIG. 10 shows, in an embodiment of the invention, a simple flow chart illustrating a transaction that requires the service of a financial institution.

At a first step 1002, a transaction request is received by the integrated mobile transaction system. Consider the situation wherein, for example, the transaction request includes a request to increase the fund in the requester's account by $200. The requester may have authorized the integrated mobile transaction system to increase the account by accessing a personal bank account.

At a next step 1004, the integrated mobile transaction system may check a database for instruction about out-of-system payment.

At a first step 1006, an order request may be sent to the designated financial institution. In an example, the integrated mobile transaction system may send an order request for $200 to be % withdrawn from the requester's bank account. In the prior art, to move the money from one bank account to another may require a wire transfer, which may not only be an expensive transaction but may also require the requester to experience a few days delay before the transaction may be completed. With the integrated mobile transaction system, the money may be moved from the bank by performing a withdrawal. Unlike a wire transfer, the transaction may occur immediately with little or no additional cost.

At a next step 1008, the integrated mobile transaction system may receive notification of the execution of the order request. Once the financial institution has performed the order request, the financial institution may send a confirmation that the order request has been processed.

At a next step 1010, the integrated mobile transaction system may update the requester's account with the additional fund. In an example, the requester may have originally $300 in his member account. After the update, the requester's account may now reflect $500. In an embodiment, the transaction may be logged into a transaction history database. In other words, a history of the transaction may be kept by the integrated mobile transaction system.

At a next step 1012, a transaction confirmation may be sent to the requester.

As can be appreciated from the foregoing, if a user wants to transfer money between two financial institutions, the steps described in FIG. 10 above may be employed. In an example, an order request may be sent to the first financial institution to withdraw a designated amount of money from the requester's account. Once the transaction has been performed, the integrated mobile transaction system may credit the user's member account accordingly. Then the integrated mobile transaction system may send a second order request to the second financial institution to accept a monetary deposit. Once the transaction has been performed by the second financial institution, confirmation may be sent to the integrated mobile transaction system. Upon receiving the confirmation, the integrated mobile transaction system may debit the user's in-system account accordingly.

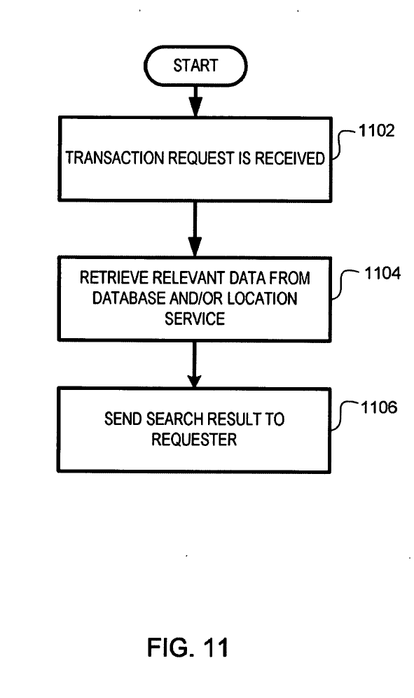

FIG. 11 shows, in an embodiment, a method for employing an integrated mobile transaction system to market a merchant and/or a product to the end-user. Consider the situation wherein, for example, Jane wants to watch a movie. In the prior art, Jane may go to the movie theatre to purchase the ticket. However, if a network computer system is available, Jane may alternatively purchase the movie ticket online and print the ticket from a kiosk at the movie theatre.

Unlike the prior art, Jane may purchase the movie ticket without standing in line at a movie theatre or having access to a computer system. At a first step 1102, a transaction request is received. In an example, Jane may send a request via a transaction-enabled device to the integrated mobile transaction system to provide a list of movie theatres that may be close to her current location.

At a next step 1104, an integrated mobile transaction system may retrieve the relevant data from a set of databases. In an example, the integrated mobile transaction system may query a set of internal databases to determine in-system merchants that may meet the criteria. In another example, the integrated mobile transaction system may utilize a location/search service to retrieve the relevant data. In an embodiment, the data retrieved may be based on the transaction request sent by the requester. Additionally or alternatively, the search result may be based on the geographic positioning of the transaction-enabled device and/or information provided by the requester (e.g., partial or full address).

At a next step 1106, the search result is provided by the integrated mobile transaction system to the requester. In an embodiment, the integrated mobile transaction system may only provide a listing of in-system merchants (i.e., merchants that are member of the integrated mobile transaction system). In another embodiment, the integrated mobile transaction system may list all merchants (e.g., movie theatres) that fit the criteria, regardless if the merchant is an in-system merchant or not. In an embodiment, a hyperlink may be provided for each merchant, thereby enabling the requester (Jane) to click on the link to retrieve additional data, if available. Additional data may include a listing of movies being shown, the show time for each movie, and the like. However, if additional data is not readily available, such as a web site, a hyperlink may not be provided.

In an embodiment, an in-system merchant may market itself to potential customers even if the in-system merchant may not have a web site. In an embodiment, the integrated mobile transaction system may include databases that may store profile data about the in-system merchants. In an example, the profile data may include products the in-system merchants sell, the price of the products, the availability of the products and the like. In the example of the movie theatres, in-system movie theatre owners may store movie listing, show times, previews, member discount, preferential seating, and the like.

In an embodiment, the integrated mobile transaction system may complete a purchase transaction. In an example, if Jane selects to purchase a movie ticket from an in-system merchant, the integrated mobile transaction system may facilitate the transaction between Jane and the in-system merchant. Once the transaction has been completed, the integrated mobile transaction system may provide a confirmation request. Additionally or alternatively, a confirmation number (e.g., bar code) may be included enabling Jane to utilize the confirmation number as a movie ticket. In an example, the movie attendant may scan the bar code provided by Jane to allow Jane access to the movie theatre. Unlike the prior art, Jane is able to purchase the movie ticket without standing in line or having access to a computer system. With the integrated mobile transaction system, informed spontaneous decision may be made without suffering the consequences (e.g., standing in a long line, tickets being unavailable, lack of information, lack of competitive data, etc.) that are usually associated with lack of planning.

For non-member merchants, the non-member merchants may appear on the list but the requester may be unable to perform a purchase transaction with the merchant through the integrated mobile transaction system. For non-member merchants, the integrated mobile transaction system may send a message to the non-member merchants about a user inquiry and may provide the non-member merchants with an opportunity to join. Alternatively, the non-member merchants may indirectly be members. In an example, a non-member merchant may be members of an aggregator that may be an in-system member. As a result, the integrated mobile transaction system may facilitate the transaction between the consumer and the non-member merchant via the in-system aggregator.

In an embodiment, the integrated mobile transaction system may facilitate a chain relationship. Consider the situation wherein, for example, an oil company may sell gas to a gas station, which may make the gas available to truck drivers. In order to stay in business, the gas station owner may have to collect payments from the truck drivers in order to continue purchasing gas from the oil companies. However, in certain part of the world, cash is the main payment method. In order for the gas station owner to pay the oil company, the gas station owner may have to make a deposit of the cash collected into a bank account before wiring the oil company the payment. If the gas station is located in a rural area in which no financial institution is available, the gas station owner may have to travel to the town with the nearest financial institution. Alternatively, the gas station owner may pay cash to the person delivering the gas and trust that the payment is correctly applied to his account with the oil company.

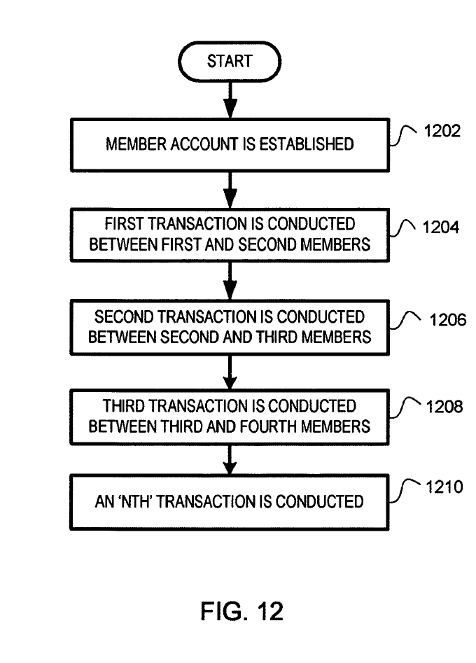

FIG. 12 shows, in an embodiment, a flow chart illustrating how an integrated mobile transaction system may be employed to facilitate a chain relationship. At a first step 1202, member accounts may be established. In an example, the owner of the truck fleet may establish an account for the truck driver, thereby enabling the truck driver to authorize an electronic payment to the gas station utilizing a transaction-enabled device. As can be appreciated from the foregoing, a chain relationship may receive the most benefit from the integrated mobile transaction system if each member of the chain relationship is also an in-system member of the integrated mobile transaction system. However, a chain relationship may still be supported even if not all members are in-system members. As aforementioned, if a member within the chain relationship is not an in-system member, the non-member may be offered the opportunity to join. Alternatively or additionally, if an in-system member needs to perform a transaction with a non-member, the integrated mobile transaction system may offer the in-system members with traditional methods of payment (e.g., sending a check, wire fund, etc.) to facilitate the transaction. As can be appreciated from the foregoing, the traditional methods of payments may be less timely since the tradition methods of payments may be subject to external limitations (e.g., the waiting period required for performing wire transfer, the time required to deliver a check, etc.).

At a next step 1204, a first transaction is initiated between a first member and a second member. In an example, the owner of the truck fleet may send a transaction request to have $300 moved from the firm account to a specific trucker driver's account. As result, the firm account may be reduced by $300 while the truck driver's account is increased by $300.

At a next step 1206, a second transaction occurs between a second member and a third member. In an example, the truck driver may purchase gas (total value of $250) from a gas station. If the gas station is an in-system merchant, the transaction may be performed electronically. In other words, the truck driver's account is reduced by $250 and the gas station's account is increased by $250. Since the transaction is performed electronically, both the truck driver and the gas station attendant are protected from theft. In addition, since the truck driver and the gas station attendant never actually have possession of the cash, neither one is able to siphon the money.

At a next step 1208, a third transaction occurs between a third member and a fourth member. In an example, the gas station owner may make payment to the oil company by transferring money via the integrated mobile transaction system.

At a next step 1210 an “nth” transaction occurs. As can be appreciated from the foregoing, an “n” number of transactions may occur depending upon the number of members within the chain relationship. Regardless of the number of transactions, the integrated mobile transaction system enables money to flow through the chain relationship without incurring the risk of theft and/or the inconvenience of having to interact with another service provider, such as a financial institution.

As can be appreciated from the forgoing, one or more embodiments of the present invention provide for integrated mobile transaction system that seems to transform a disconnected transaction system into a single comprehensive transaction architecture. With the integrated mobile transaction system, members may perform day-to-day activities by employing a common transaction-enabled device, such as a mobile telephone, without having the burden of keeping track of transaction-enabled cards. By converting the transaction-enabled cards into electronically accessible data that is remotely located, a user's privacy is respected and protected without limiting the user's ability to perform transactions. As a single comprehensive system, the integrated mobile transaction system further provides the user with a real-time availability of his discretionary fund. In an example, the integrated mobile transaction system is able to keep track of a user's current and committed expenses along with the user's available and incoming funds across his diverse accounts and pending transactions. Therefore, the integrated mobile transaction system empowers the user to make informed financial decisions.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. An architectural transaction arrangement for facilitating transactions initiated by a transaction request, comprising:
an integrated mobile transaction system configured to manage relationships between a user and a plurality of service providers, wherein said integrated mobile transaction system includes:
a set of interfaces, said set of interfaces being configured for managing interaction between a transaction-enabled device and said integrated mobile transaction system,
a transaction module in communication with the set of interfaces, said transaction module being configured to process said transactions between said transaction-enabled device and a plurality of service providers, and
a set of databases in communication with the transaction module, said set of databases being configured for at least storing authentication data about a user of said integrated mobile transaction system, a plurality of transaction-enabled cards associated with said user, authentication identification data associated with a user, and a rule associated with said authentication identification data.

2. The architectural transaction arrangement of claim 1 wherein said integrated mobile transaction system further including a web converter, said web converter being configured for converting one of a set of protocols associated with said transaction requests from said transaction-enabled device into a network-enabled protocol associated with said transaction module.

3. The architectural transaction arrangement of claim 2 wherein said set of transaction-enabled devices include a mobile telecommunication device.

4. The architectural transaction arrangement of claim 2 wherein said transaction module include a set of operation centers, said set of operation centers being geographically dispersed thereby enabling said integrated mobile transaction system to be a scalable modular module to facilitate a global transaction environment.

5. The architectural transaction arrangement of claim 2 wherein said set of databases include at least one of
a member database, said member database being configured to include for each in-system user of said set of in-system users at least one of
a unique identifier associated with a transaction-enabled device,
a unique identifier associated with said in-system user,
a set of authentication data,
an image unique to said in-system user, and
a set of transaction-enabled cards, wherein data associated with each transaction-enabled card of said set of transaction-enabled cards include at least one of transaction-enabled card unique identifier, expiration date, name of vendor, monetary limit, and image of said transaction-enabled card; and
a transaction history database, wherein said transaction history database being configured to store said transactions processed by said integrated mobile transaction system.

6. The architectural transaction arrangement of claim 2 wherein said integrated mobile transaction system authentication identification data includes a multiple pin arrangement, wherein said multiple pin arrangement includes at least a primary pin and a secondary pin, said primary pin being associated with initial authentication and said secondary pin being associated with one or more transaction-enabled cards either directly or with a user-configured monetary limit.

7. The architectural transaction arrangement of claim 2 wherein said integrated mobile transaction system is configured for at least facilitating a transaction request from a first transaction-enabled device wherein said facilitating comprising
receiving said transaction request from said first transaction-enabled device;
receiving an authentication identification data from said first transaction-enabled device;
authenticating said authentication identification data against data stored on said set of databases;
if said authentication identification data is valid and sufficient, processing said transaction request;
if said authentication identification data is valid but insufficient, a request for further authentication is sent to the first transaction-enabled device; and
sending said first transaction-enabled device a transaction confirmation, said transaction confirmation being configured to notify said first transaction-enabled device that said transaction request has been processed.

8. The architectural arrangement of claim 7 wherein said processing of said transaction request further including:
sending an order request to a second transaction-enabled device of said set of transaction-enabled devices, and
receiving an order confirmation from said second transaction-enabled device after said second transaction-enabled device has processed said second transaction request.

9. The architectural arrangement of claim 5 wherein said transaction request is at least one of a non-financial transaction request and a financial transaction request.

10. The architectural arrangement of claim 2 wherein said integrated mobile transaction system is configured for generating new membership while processing a transaction request by automatically sending a message to a transaction-enabled device when said transaction-enabled device is identified as a non-member.

11. A method for managing a set of transaction requests from a first user of a first transaction-enabled device, implemented within an integrated mobile transaction system, said method comprising:
using said integrated mobile transaction system to receive a transaction request of said set of transaction requests by an integrated mobile transaction system;
using said integrated mobile transaction system to perform authentication of said first user of said first transaction-enabled device by
using said integrated mobile transaction system to compare a primary pin against authentication data associated with said first user, said authentication data being stored within a set of databases;
if said first user is authenticated, using said integration mobile transaction system to determine, based on one or more rules associated with the first user, if the authentication data is sufficient for the transaction;
if said authentication data is determined to be sufficient, using said integrated mobile transaction system to process said transaction request;
if said authentication data is determined to be insufficient, using said integrated mobile transaction system to send a request for further authentication data from the first user; and
using said integrated mobile transaction system to send said first transaction-enabled device a transaction confirmation, said transaction confirmation being configured to notify said first transaction-enabled device that said transaction request has been processed
wherein said integrated mobile transaction system comprises at least:
a set of interfaces, said set of interfaces being configured for managing interaction between said transaction-enabled device and said integrated mobile transaction system,
a transaction module, said transaction module being configured to process transactions, and
a set of databases, said set of databases being configured for at least storing data about a user of said integrated mobile transaction system, a plurality of transaction-enabled cards associated with said user of said integrated mobile transaction system, one or more Personal Identification Numbers (PINs) associated with a user, and a rule associated with said PIN.

12. The method of claim 11 further including:
using said integrated mobile transaction system to convert a protocol associated with said transaction request into a network-enabled protocol; and
transforming said transaction request into a set of business process instructions readable by said integrated mobile transaction system.

13. The method of claim 12 wherein said processing of said transaction request by said integrated mobile transaction system includes:
sending an order request to a second transaction-enabled device, and
receiving an order confirmation from said second transaction-enabled device after said second transaction-enabled device has processed said order request.

14. The method of claim 13 wherein said transaction request is at least one of a financial transaction request and a non-financial transaction request.

15. The method of claim 14 wherein if said transaction request is a financial transaction request, validating fund availability by said integrated mobile transaction system before processing said transaction request, wherein said fund availability includes combining a plurality of available funds to facilitate said transaction request, and if said plurality of available funds associated with said primary pin is insufficient, said integrated mobile transaction system is configured to send a message to said first transaction-enabled device requesting for additional instruction, wherein said additional instruction includes a request for a secondary pin, wherein said secondary pin is associated with at least one of a higher monetary limit and a different monetary source.

16. The method of claim 15 wherein said processing of said transaction request by said integrated mobile transaction system further includes facilitating fund transfer from said available fund of said first user to an account of a second user, said second user being associated with said second transaction-enabled device.

17. The method of claim 16 wherein said integrated mobile transaction system is configured to provide said first user with a real-time availability of discretionary fund across one or more the financial accounts associated with said transaction-enabled cards.

18. The method of claim 11 wherein new membership for said integrated mobile transaction system is generated by at least one of
using said integrated mobile transaction system to automatically send a first message to a second transaction-enabled device, wherein said first message is automatically sent when said second transaction-enabled device is identified with an out-of-system user of said integrated mobile transaction system, and said first message includes instructions for enabling an out-of-system user associated with said second transaction-enable device to become an in-system user; and
said first transaction-enabled device sending a second message to said second transaction-enabled device, wherein said second message includes instructions for enabling said second transaction-enable device to become an in-system device, thereby enabling said out-of-system user to become a member of said integrated mobile transaction system.

19. The method of claim 11 wherein said integrated mobile transaction system is configured for performing load balancing by distributing said set of transaction requests to a plurality of operation centers, said plurality of operation centers being geographically dispersed, thereby enabling a scalable modular module to facilitate a global transaction environment

20. (canceled)

21. The architectural transaction arrangement of claim 1 wherein said integrated mobile transaction system further including a format converter, said format converter being configured to convert said transaction request from a human-readable format into a format readable by said transaction module.
